(19) United States
(12) Patent Application Publication
(10) Pub. No.: US 2014/0004438 A1
(43) Pub. Date: Jan. 2, 2014

(54) FUEL CELL SYSTEM AND METHOD OF OPERATING FUEL CELL SYSTEM

(71) Applicant: HONDA MOTOR CO., LTD., Tokyo (JP)

(72) Inventors: Chihiro WAKE, Saitama (JP); Tomohisa KAMIYAMA, Saitama (JP); Yuji MATSUMOTO, Saitama (JP)

(21) Appl. No.: 13/927,475

(22) Filed: Jun. 26, 2013

(30) Foreign Application Priority Data
Jun. 27, 2012 (JP) 2012-144661

(51) Int. Cl. H01M 8/04

(52) U.S. Cl. CPC H01M 8/04544; H01M 8/04798
USPC 429/444

(57) ABSTRACT

A fuel cell system includes: a fuel cell stack, a hydrogen gas tank, a compressor, an oxidant gas supplying flow passage, an oxidant off-gas discharge flow passage, a diluter for diluting an anode off-gas with a cathode off-gas, a branched gas flow passage through which a branched gas is directed to the diluter, a back pressure valve for controlling a pressure of branched gas, an OCV determining unit, and an I-V characteristic decreasing unit for starting power generation of the fuel cell stack and decreasing an I-V characteristic of the single cell by decreasing a stoichiometric ratios. In a low temperature start-up, the back pressure valve decreases a pressure of the branched gas introduced into the diluter when the I-V characteristic of the single cell is decreased by the I-V characteristic decreasing unit. An operation method of operating the fuel cell system is also disclosed.

### CROSS REFERENCE TO RELATED APPLICATION

This application claims the foreign priority benefit under Title 35, United States Code, §119(a)-(d) of Japanese Patent Application No. 2012-144661, filed on Jun. 27, 2012 in the Japan Patent Office, the disclosure of which is herein incorporated by reference in its entirety.

### BACKGROUND OF THE INVENTION

1. Field of the Invention

The present invention relates to a fuel cell system and a method of operating a fuel cell system.

2. Description of the Related Art

In recent years, as a power source for a fuel cell vehicle, etc., a fuel cell has attracted notices, which generates electricity with supply of hydrogen gas (fuel gas) and an air including oxygen (oxidant gas). Such a fuel cell has a preferable temperature at which the fuel cell preferably generates electricity in accordance with a kind of a catalyst (Pt, etc.) for electrode reaction with hydrogen gas or the air (for example, 80 to 90 degrees centigrade in PEFC).

Incidentally, because environment of usage of the fuel cell may largely vary, the temperature of the fuel cell at a start-up operation largely varies, for example, the temperature may become below zero (lower than 0 degrees centigrade). Then, a method has been proposed (for example, patent document 1) in which an I-V characteristic of the fuel cell is lowered by decreasing a stoichiometric ratio of the air (oxygen) fed to the fuel cell, as a method of a rapidly warming up the fuel cell (for example, JP 2008-226591A). Here, as a method of decreasing the stoichiometric ratio of the air (oxygen), for example, a method of decreasing a flow rate of the air toward the fuel cell may be adopted. In addition, to lower the I-V characteristic of the fuel cell unit to decrease the I-V curve of the fuel cell.

The “stoichiometric ratio of oxygen” unit a surplus ratio of oxygen and is a ratio (a flow rate of actually supplied oxygen/a required flow rate of oxygen) indicating to what extent is oxygen actually supplied to the anode surplus relative to a required quantity of oxygen (required oxygen flow rate) for reaction with hydrogen supplied to the anode without excess and lack.

If the stoichiometric ratio is decreased while an output current of the fuel cell is kept unchanged, an output voltage of the fuel cell decreases, so that the I-V characteristic (I-V curve) of the fuel cell will decrease. Accordingly, a heat loss (electric power generation loss) out of the energy taken out from the reaction of the hydrogen with oxygen will increase, that is, a self heat generation quantity associated with power generation in the fuel cell will increase. Therefore, when the stoichiometric ratio is decreased to make the status close to an insufficient oxygen status, the I-V characteristic (I-V curve) of the fuel cell will decrease, which increases a concentration overvoltage and a self heat generation quantity, so that warm-up of the fuel cell is accelerated. Incidentally, such an operation of decreasing the stoichiometric ratio is called “low efficiency operation”.

In addition, a technology is known in which hydrogen gas exhausted from an anode flow passage (fuel gas flow passage) is returned to an upstream of the fuel cell because a part of hydrogen gas has not consumed in power generation and to be resupplied to the upstream of the fuel cell for increase in a consumption ratio of hydrogen gas, i.e., a fuel cell system including a hydrogen gas circulating system for circulating hydrogen gas is known.

In addition, to increase a hydrogen concentration in the anode flow passage in startup of the system, there is a general process of substituting a gas in a fuel gas flow passage with hydrogen gas and a power generation in the fuel cell is started after an open circuit voltage (OCV: Open Circuit Voltage) becomes equal to or greater than a predetermined OCV.

When the gas in the anode flow passage is substituted with hydrogen, a purge valve (exhaust valve) connected to the hydrogen gas circulating system is repeatedly opened for a predetermined opening period to exhaust a gas staying in the hydrogen circulating system communicating with the anode flow passage and a new hydrogen gas (new fuel gas) is introduced into the anode flow passage from the hydrogen gas tank (fuel gas supplying unit) to increase a hydrogen concentration. The sequential process from opening and closing the purge valve as described above to increase the hydrogen concentration by promoting the hydrogen gas substitution, up to when the OCV becomes equal to or greater than a predetermined OCV is called “OCV check process”.

In addition, another technology is known in which a hydrogen gas coming from the purge valve is introduced into a diluter where the hydrogen gas is diluted with a cathode gas coming from the cathode flow passage (oxidant gas flow passage), and exhausted outside the vehicle to prevent a hydrogen gas from the purge valve from being exhausted outside the vehicle (outside) without any process.

However, in a case where the purge valve is opened at the end, just before, or just after the end of the OCV check process, if the low efficiency operation is started, in which the stoichiometric ratio of the air (oxygen) is decreased, i.e., a flow rate of supplied air is decreased, to lower the I-V characteristic of the fuel cell, a flow rate of the cathode off-gas as the diluting gas will decrease. Accordingly, there may be a case where the hydrogen gas exhausted when the purge valve is opened at the end, just before, or just after the end is not preferably deleted with the cathode off-gas.

In a case of the configuration assuming that, when the concentration of the hydrogen in the gas exhausted outside the vehicle is equal to or greater than a predetermined hydrogen concentration, the low efficiency operation is stopped, the low efficiency operation is interrupted, when a lack of dilution of the hydrogen gas is detected with a hydrogen sensor, etc., so that the warm-up operation of the fuel cell may be delayed.

### SUMMARY OF THE INVENTION

The present invention may provide a fuel cell system capable of rapidly warming up a fuel cell and a method of operating the fuel cell system.

A first aspect of the present invention provides a fuel cell system comprising:

a fuel cell, including a fuel gas flow passage and an oxidant gas flow passage, configured to generate an electric power with supply of the fuel gas to the fuel gas flow passage and the oxidant gas to the oxidant gas flow passage;

fuel gas supplying unit for supplying the fuel gas into the fuel gas flow passage;

an oxidant gas supplying unit for supplying the oxidant gas into the oxidant gas flow passage;

an oxidant gas supplying flow passage, extending from the oxidant gas supplying unit to the oxidant gas flow passage, through which the oxidant gas flows;

an oxidant off-gas discharge flow passage through which the oxidant off-gas discharged from the oxidant gas flow passage flows;

a diluter, installed in the oxidant off-gas discharge flow passage, configured to dilute the fuel off-gas discharged from the fuel gas flow passage with the oxidant off-gas;

a branched gas flow passage configured to connect the oxidant gas flow passage or the oxidant off-gas discharge flow passage upstream from the diluter to the diluter and allow a branched gas to flow toward the diluter;

a pressure controlling unit configured to control a pressure of the branched gas;

an OCV determining unit configured to determine whether an OCV of the fuel cell is equal to or greater than a predetermined OCV at a system startup; and

an I-V characteristic decreasing unit configured to start generation of the electric power in the fuel cell after the OCV determining unit determines that the OCV of the fuel cell is equal to or greater than the predetermined OCV and decreasing an I-V characteristic of the fuel cell by decreasing a stoichiometric ratio of the oxidant gas,

wherein the pressure controlling unit decreases the pressure of the branched gas introduced into the diluter when the I-V characteristic of the fuel cell is decreased by the I-V characteristic decreasing unit.

In this system, the fuel off-gas includes a fuel gas not consumed in power generation.

With such a configuration, when the I-V characteristic of the fuel cell is decreased (in the warm-up operation of the fuel cell) by the I-V characteristic decreasing unit (warm-up unit), pressure control unit decreases the pressure of the branched gas introduced into the diluter.

Then, the pressure of the branched gas decreases, so that a pressure of the introducing chamber within the diluter (staying chamber, diluting chamber) decreases, so that the fuel off-gas is not easily pushed out to an outlet side (outer side) by the branched gas, and the fuel off-gas is staying in the introducing chamber. Accordingly, the fuel gas can be easily diluted by natural dissipation, etc. This can preferably decreases a fuel gas concentration in the diluted gas exhausted from the diluter to outside (outside the vehicle in an embodiment which will be described), in other words, this prevents the fuel gas from being exhausted without dilution of the fuel off-gas. As described above, the I-V characteristic of the fuel cell is decreased by the I-V characteristic decreasing unit to warm up the fuel cell as well as the fuel gas concentration of the gas exhausted to the outside can be preferably decreased.

A second aspect of the present invention provides the fuel cell system based on the first aspect, wherein the diluter comprising:

a case including an introducing chamber into which the fuel off-gas is introduced;

an oxidant off-gas pipe, penetrating the case, through which the oxidant off-gas flows;

a suction hole, formed in the oxidant off-gas pipe in the case and providing communication between outside and inside of the oxidant off-gas pipe;

wherein with a decrease in a flow rate of the oxidant off-gas flowing through the oxidant off-gas pipe a suction quantity of the fuel off-gas suctioned into the oxidant off-gas pipe through the suction hole from the introducing chamber decreases.

With such a configuration, as the flow rate decreases with decrease in the pressure of the oxidant off-gas, a suction quantity of the fuel off-gas suctioned into the oxidant off-gas tube through a suction hole from the introducing chamber decreases. This preferably decreases the fuel gas concentration in the diluted gas exhausted from the diluter to the outside.

A third aspect of the present invention provides the fuel cell system based on the first aspect, wherein the branched gas flow passage is connected to the oxidant gas supplying flow passage, and the pressure controlling unit comprises a back pressure valve installed in the oxidant off-gas flow passage between the oxidant gas flow passage and the diluter.

With such a configuration, controlling an opening degree of the back pressure valve installed in the oxidant off-gas flow passage between the oxidant gas flow passage and the diluter can adjust the pressure of the oxidant gas in the oxidant gas flow passage of the fuel cell in accordance with, for example, a required power generation quantity.

In addition, because the branched gas flow passage is configured to be connected to the oxidant gas supplying flow passage more upstream than the back pressure valve, the pressure of the branched gas can be controlled by controlling the opening angle of the backpressure valve. In other words, as the opening degree of the back pressure valve increases, the pressure of the branched gas may decrease.

As described above, controlling the opening degree of the back pressure valve can control the pressure of the oxidant gas in the oxidant gas flow passage and the pressure of the branched gas introduced in the diluter.

Accordingly, the present invention provides a fuel cell system in which the fuel cell can be rapidly warmed up and a method of operating the fuel cell system.

### BRIEF DESCRIPTION OF THE DRAWINGS

The object and features of the present invention will become more readily apparent from the following detailed description taken in conjunction with the accompanying drawings in which: with like references throughout the drawings.

FIG. 1 is a block diagram of a fuel cell system according to an embodiment of the present invention.

FIG. 2 is a block diagram of a diluter according to the embodiment.

FIG. 3 is a flowchart indicating an operation of the fuel cell system according to the embodiment.

FIG. 4 shows a map indicating a relation between a temperature of a fuel cell stack and a target heat generation quantity.

FIG. 5 shows a map indicating a relation between the target heat generation quantity and a target stack current (target cell current).

FIG. 6 shows a map indicating a relation between the target stack heat generation quantity and a target stuck voltage.

FIG. 7 shows a map indicating a relation between a target stoichiometric ratio and a concentration overvoltage (target stack voltage).

FIGS. 8A to 8F are time charts indicating an operation example of a fuel cell system according to the embodiment.

### DETAILED DESCRIPTION OF THE INVENTION

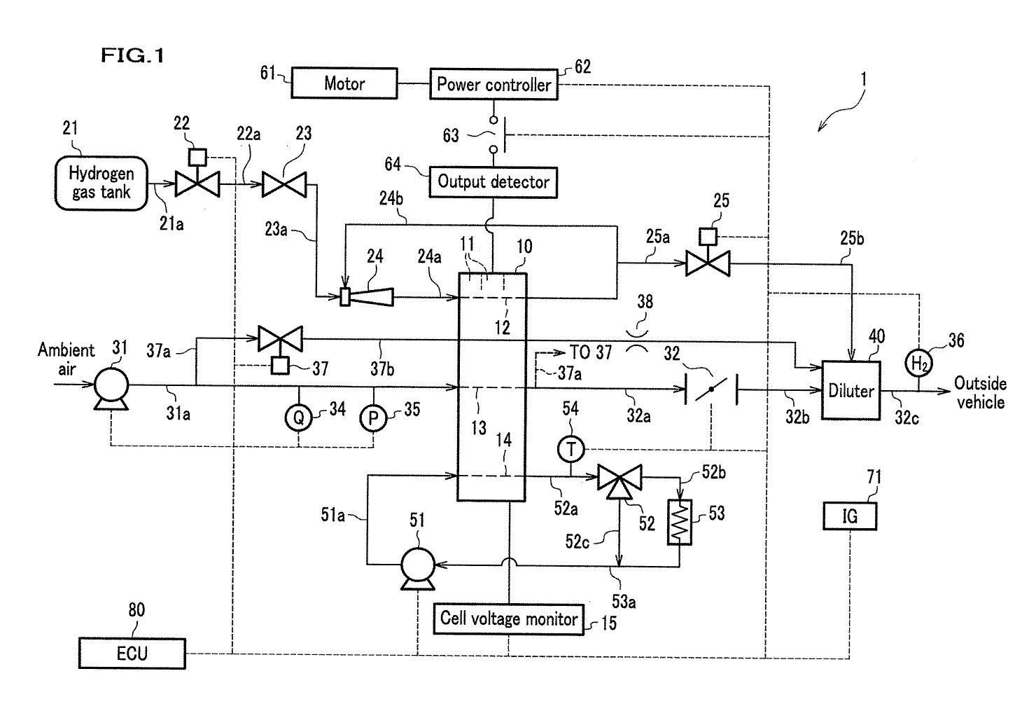

With reference to FIGS. 1 to 8F, will be described an embodiment of the present invention.

### <<Configuration of Fuel Cell System>>

An fuel cell system 1 is mounted on a fuel cell vehicle (not shown) and includes an fuel cell stack 10 (fuel cell), a cell voltage monitor 15, an anode system for supplying and exhausting hydrogen gas (fuel gas, anode gas) to and from an anode of the fuel cell stack 10, a cathode system for supplying and exhausting the air (oxidant gas, cathode gas) to or from the cathode of the fuel cell stack 10, a coolant system for circulating a coolant through the fuel cell stack 10, a power control system for controlling a power (stack current, stack voltage) outputted by the fuel cell stack 10, and an ECU 80 (Electronic Control Unit, control unit) for electronically controlling these devices.

### <Fuel Cell Stack>

The fuel cell stack 10 is a stack formed by stacking a plurality (for example, 200 to 400) of single cells (fuel cells) 11 of solid polymer type, in which a plurality of the single cells (fuel cell) 11 are electrically connected in series. The single cell 11 includes an MEA (Membrane Electrode Assembly) and two sheets of separators, having an electric conductivity, sandwiching the MEA. The MEA includes an electrolyte film (proton exchange membrane) comprising a univalent positive ion exchanging film and an anode and a cathode (electrodes) sandwiching the MEA.

The anode and the cathode includes a porous material having an electric conductivity such as a carbon paper and a catalyst (Pt, Ru, etc.) for generating an electrode reaction in the anode and the cathode supported by the porous materials.

Each of the separators includes channels for supplying the hydrogen gas or the air over a whole surface of each MEA and through holes for supplying and exhausting the hydrogen gas or the air to and from all of the single cells 11. These channels and through holes respectively function as an anode flow passage 12 (fuel gas flow passage) and a cathode flow passage 13 (oxidant gas flow passage).

When each of the anodes is supplied with the hydrogen gas through the anode flow passage 12, an electrode reaction given by Eq. (1) occurs and each of the cathodes is supplied with the air through the cathode flow passage 13, an electrode reaction given by Eq. (2) occurs. Accordingly, a potential difference is developed at each single cell (OCV: Open Circuit Voltage). Next, when the fuel cell stack 10 is electrically connected to an external circuit such as a motor 61, and a current is taken out, the fuel cell stack 10 starts generating an electricity.

2H₂→4H⁺+4e⁻ (1)

O₂+4H⁺+4e⁻→2H₂O (2)

In each of the separators, channels allowing a coolant to flow therethrough to cool the single cell 11 and through holes for supplying and exhausting the coolant to and from all of the single cells 11 are formed, these channels and through holes functioning as a coolant flow passage 14.

### <Cell Voltage Monitor>

The cell voltage monitor 15 is a device for detecting a cell voltage of each of a plurality of the single cells 11 and includes a monitor body and a wire harness for connecting the monitor body and each of the single cells.

The monitor body scans all of the single cells 11 at a predetermined cycle to detect the cell voltage of each of the single cells 11 to calculate an average cell voltage and a minimum cell voltage. The monitor body (cell voltage monitor 15) outputs and supplies the averaged cell voltage and the minimum cell voltage to an ECU 80.

### <Anode System>

An anode system includes a hydrogen gas tank 21 (fuel gas supplying unit, fuel gas supplying unit), a shutoff valve 22 of a normally close type, a pressure reducing valve 23 (regulator), an ejector 24, and a purge valve 25 of a normally close type.

The hydrogen gas tank 21 is connected to an inlet of the anode flow passage 12 through a pipe 21a, the shutoff valve 22, a pipe 22a, the pressure reducing valve 23, a pipe 23a, the ejector 24, and a pipe 24a. When the shutoff valve 22 is opened by the ECU 80, a hydrogen gas in the hydrogen gas tank 21 is supplied to the anode flow passage 12 through the pipe 21a, etc.

Accordingly, the fuel gas flow passage, in which the fuel gas to be supplied to the anode flow passage 12 flows, is configured to include the pipe 21a, the pipe 22a, the pipe 23a, and the pipe 24a.

The pressure reducing valve 23 reduces (controls) a pressure of the hydrogen gas to equalize the pressure of the hydrogen gas to a pressure of the air flowing through the cathode flow passage 13.

The ejector 24 is a device (vacuum pump) for generating a negative pressure by ejecting the hydrogen gas from the pipe 23a with a nozzle (not shown) to suction an anode off-gas containing a hydrogen gas (described later) with the negative pressure to circulate the hydrogen gas.

An outlet of the anode flow passage 12 is connected to a suction inlet of the ejector 24 through a pipe 24b (hydrogen gas circulating line). The anode off-gas (fuel off-gas) containing an unreacted hydrogen gas exhausted from the anode flow passage 12 is supplied to the ejector 24 through the pipe 24b to circulate the hydrogen gas.

The pipe 24b is connected to a diluter 40 described later through a pipe 25a, the purge valve 25, and a pipe 25b. When the purge valve 25 is opened by the ECU 80 for a predetermined opening period, the anode off-gas containing the unreacted hydrogen and an impurity (water (water vapor), nitrogen, etc.) is exhausted to the diluter 40 to recover a power generation performance of the fuel cell stack 10.

In addition, the ECU 80 is configured to make determination that it is necessary to open the purge valve 25, when the minimum voltage (minimum cell voltage) outputted by one of the single cells 11 is equal to or smaller than a predetermined cell voltage.

### <Cathode System>

The cathode system includes a compressor 31 (oxidant gas supplying unit, pressure control unit), a back pressure valve 32 of a normal open type (pressure control unit), the diluter 40, a flow rate sensor 34, a pressure sensor 35, and a hydrogen gas sensor 36.

A discharging outlet of the compressor 31 is connected to an inlet of the cathode flow passage 13 through a pipe 31a (oxidant gas supplying flow passage). When operating in accordance with an instruction from the ECU 80, the compressor 31 suctions the air (ambient air) containing oxygen and then discharges the air to supply the air to the cathode flow passage 13 through the pipe 31a.

In addition, when a rotational speed of the compressor 31 (stoichiometric ratio control unit) is controlled, a flow rate (supply quantity) of the air (oxygen) to be supplied to the cathode flow passage 13 is controlled to change the stoichiometric ratio of oxygen. Further, the compressor 31 and a coolant pump 51 described later are connected to at least one of the fuel cell stack 10 and a battery (not shown) as an electric power source.

An outlet of the cathode flow passage 13 is connected to a pipe 32a, the back pressure valve 32, a pipe 32b, the diluter 40, and a pipe 32c in this order. The cathode off-gas (oxidant off-gas) exhausted from the cathode flow passage 13 is discharged to the outside of the vehicle through the pipe 32a, etc.

Accordingly, the oxidant off-gas discharge flow passage through which the cathode off-gas discharged from the cathode flow passage 13 flows is configured to include the pipe 32a, the pipe 32b, and the pipe 32c. The diluter 40 is installed in the oxidant off-gas discharging flow passage, and the back pressure valve 32 is installed in the oxidant off-gas flow passage between the cathode flow passage 13 and the diluter 40.

The back pressure valve 32 is a valve to control a back pressure thereof (pressure of the air, etc. in the cathode flow passage 13), and a pressure of the cathode off-gas flowing through a pass-through pipe 43 described later and configured with a valve of which opening angle is controllable such as a butterfly valve, and a needle valve. The opening angle is controlled by the ECU 80.

An upstream side of the back pressure valve 32 is communicated with the pipe 32a, the cathode flow passage 13, the pipe 31a, a pipe 37a, and a pipe 37b. Accordingly, when the opening angle of the back pressure valve 32 is controlled, a pressure of the bypass air (branched gas) introduced into the diluter 40 through the pipe 37a and the pipe 37b is controlled in addition to the pressure of the air in the cathode flow passage 13 (cathode pressure). For example, with this configuration, when the opening angle of the back pressure valve 32 is increased, a pressure in the bypass air pressure decreases. Accordingly, a pressure control unit for controlling the pressure of the bypass air (branched gas) introduced into the diluter 40 is configured with the back pressure valve 32 and the ECU 80 for controlling the opening angle of the back pressure valve 32.

### <Diluter>

The diluter 40 is a box-like container for mixing the anode off-gas with the cathode off-gas to dilute the hydrogen gas contained in the anode off-gas and includes a diluting space therein (an introducing chamber 42 described later) for mixing (diluting). The gas after dilution is exhausted to the outside of the vehicle through the pipe 32c.

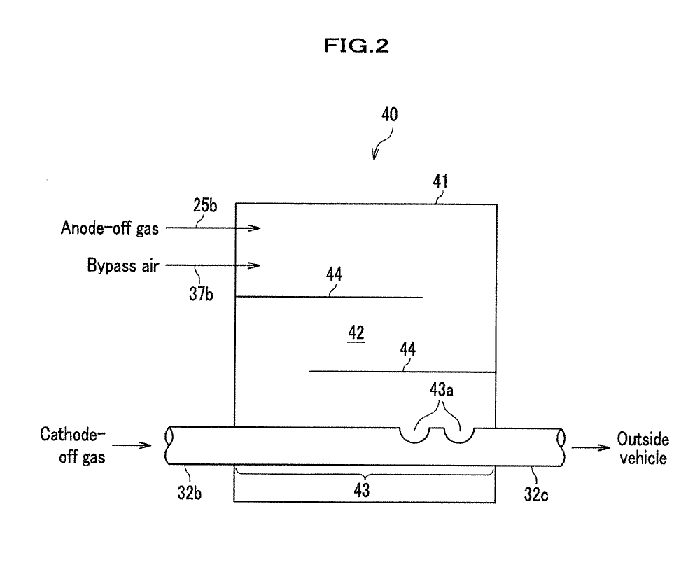

With reference to FIG. 2, the diluter 40 will be described more specifically.

The diluter 40 includes a box 41, the pass-through pipe 43, and two (a plurality of) flow passage forming plates 44, 45.

The box 41 is a box, which is a main member of the diluter 40 and has the introducing chamber 42 (staying chamber) therein. The introducing chamber 42 is a space, into which the anode off-gas from the pipe 25b (the purge valve 25) and the bypass air (branched gas) from the pipe 37b are introduced, for diluting the hydrogen gas by dissipation while the anode off-gas and the bypass air temporality staying there.

More specifically, a downstream end of the pipe 25b penetrates a wall of an upper part of the box 41 and opens in the introducing chamber 42 to introduce the anode off-gas into the introducing chamber 42. A downstream end of the pipe 37b penetrates the wall of the upper part of the box 41 and opens in the introducing chamber 42 at substantially the same position as the pipe 25b to introduce the bypass air having bypassed the fuel cell stack 10 to introduce the bypass air into the introducing chamber 42.

Timing of introducing the anode off-gas and the bypass air, i.e., timing of opening and closing the purge valve 25 and an assist valve 37 described later, is determined such that, for example, after the anode off-gas is introduced into the introducing chamber 42, the bypass air is introduced into the introducing chamber 42 so that the bypass air having introduced later can push the anode off-gas toward suction holes 43a.

Next, a degree of pushing the anode off-gas by the bypass air is dependent on the pressure of the bypass air.

More specifically, because a pressure difference between the opening part of the pipe 37b (an upstream part of the introducing chamber 42) and inside of the pass-through pipe 43 becomes larger with an increase in the pressure of the bypass air, the bypass air can easily push the anode off-gas.

In contrast, with decrease in the pressure of the bypass air, the pressure difference between the opening part of the pipe 37b (upstream part of the introducing chamber 42) and the inside of the pass-through pipe 43 decreases, which makes it more difficult for the bypass air to push the anode off-gas. More specifically, the anode off-gas tends to stay more in the introducing chamber 42. In other words, a staying period of the anode off-gas in the introducing chamber 42 becomes longer, so that a gas flow substantially disappears. Then, the dilution of the anode off-gas (hydrogen) in the introducing chamber 42 can preferably proceed by self-diffusion (volume expansion), so that the hydrogen concentration can be decreased.

The pass-through pipe 43 horizontally extends and penetrates walls near the bottom of the box 41, an upstream end of which is connected to the pipe 32b, a downstream end of which is connected to the pipe 32c. The cathode off-gas flows through the pipe 32b, the pass-through pipe 43, and the pipe 32c in this order. In other words, the oxidant off-gas piping, through which the cathode off-gas (oxidant off-gas) flows, is configured to include the pipe 32a, the pipe 32b, the pass-through pipe 43 and the pipe 32c, wherein the pass-through pipe 43, which is a part of the oxidant off-gas piping, penetrates the box 41.

At a part of the pass-through pipe 43 near the pipe 32c, a plurality (two in FIG. 2) of the suction holes 43a are formed, so that the inside and outside of the pass-through pipe 43 (the inside of the pass-through pipe 43 and the introducing chamber 42) are communicated with each other through the suction holes 43a. When the cathode off-gas flows through the pass-through pipe 43, a pressure near the suction holes 43a decreases (a negative pressure is generated), so that the anode off-gas is suctioned into the pass-through pipe 43 through the suction holes 43a. Next, in the pipe 32c downstream of the suction hole 43a of the pass-through pipe 43, as flowing, the anode off-gas is mixed with the cathode off-gas, so that the hydrogen gas included in the anode off-gas is preferably diluted.

There is such a relation that a degree of decreases in the pressure near the suction hole 43a, i.e., a degree of tendency of the negative pressure relative to the introducing chamber 42, increases with increase in the pressure of the cathode off-gas flowing through the pass-through pipe 43 (as increase in a flow rate). In other words, when the compressor 31 and the back pressure valve 32 are controlled to prevent the flow rate of the cathode off-gas flowing through the pass-through pipe 43 from varying (controlled to be substantially constant), the pressure in the pass-through pipe 43 becomes substantially constant.

Two flow passage forming plates 44, 44 are plates fixed to inner walls of the box 41 for forming a zigzag flow passage to elongate the flow passages in the box 41 from the downstream openings of the pipe 25b and the pipe 37b to the suction holes 43a. When the flow passages are elongated as described above, the staying period of the anode off-gas in the introducing chamber 42 becomes longer, so that the hydrogen concentration can be preferably decreased by dispersion of hydrogen gas in the introducing chamber 42.

Returning to FIG. 1, description will be continued.

The flow rate sensor 34 is attached to the pipe 31a. The flow rate sensor 34 detects a flow rate of the air (oxygen) supplied to the cathode flow passage 13 and supplies the detected value to the ECU 80.

The pressure sensor 35 is attached to the pipe 31a. The pressure sensor 35 detects a pressure of the air (substantially equal to the pressure in the cathode flow passage 13) supplied to the cathode flow passage 13 and supplies the detected value to the ECU 80.

The hydrogen gas sensor 36 is a sensor of, for example, a catalytic combustion type, for detecting a hydrogen concentration and attached to the pipe 32c. The hydrogen gas sensor 36 detects a hydrogen concentration in the diluted gas exhausted outside the vehicle and supplies the result to the ECU 80.

The pipe 31a is connected to the diluter 40 through the pipe 37a, the assist valve 37 of normally close type, and the pipe 37b. When the assist valve 37 is opened by the ECU 80, a part of the air exhausted from the compressor 31 is introduced into the diluter 40 as a bypass air (branched gas) bypassing the fuel cell stack 10.

In other words, the oxidant gas supplying flow passage is connected to the diluter 40 as well as the branched gas flow passage through which the bypass air (branched gas) flowing toward the diluter 40 is configured with the pipe 37a and the pipe 37b.

The assist valve 37 is configured to be opened for a predetermined opening period by the ECU 80 after the purge valve 25 has been closed. This configuration allows the bypass air to be introduced into the diluter 40 after the anode off-gas has been introduced into the 40. An orifice 38 is installed in the pipe 37b to decrease a flow rate of the bypass air.

### <Coolant System>

The coolant system is a system for circulating the coolant via the coolant flow passage 14 and includes the coolant pump 51 for pressure-sending the coolant, the a thermostat 52 for switching a flow direction of the coolant, a radiator 53 (heat radiator) for radiating a heat of the coolant outside the vehicle (atmosphere), and a temperature sensor 54 (temperature detecting unit).

Connection is made, in order from the exhausting outlet of the coolant pump 51, a pipe 51a, the coolant flow passage 14, a pipe 52a, the thermostat 52, the pipe 52b, the radiator 53, to a pipe 53a, wherein a downstream end of the pipe 53a is connected to a suction inlet of the coolant pump 51. When the coolant pump 51 is operated in accordance with an instruction by the ECU 80, there is a configuration to circulate the coolant through the coolant flow passage 14 and the radiator 53.

The thermostat 52 is connected to the pipe 53a through a pipe 52c (radiator bypass flow passage). The thermostat 52 is a direction switching valve for changing a flow direction of the coolant to a side of the pipe 52c when the temperature of the coolant is low at, for example a low temperature startup of the system. When the switching is made as described above, the coolant flows through the pipe 52c and bypasses the radiator 53.

The temperature sensor 54 is attached to the pipe 52a to detect a temperature T1 of the coolant just after the coolant flows out from the coolant flow passage 14 to supply an output to the ECU 80. The temperature T1 of the coolant is substantially equal to the temperature of the fuel cell stack 10.

### <Power Control System>

A power control system includes the motor 61, a power controller 62, the contactor 63, and an output detector 64. The motor 61 is connected to an output terminal of the fuel cell stack 10 through the power controller 62, the contactor 63, and the output detector 64.

The motor 61 is a motor for generating a drive force to cause the fuel cell vehicle to travel.

In addition, a PDU (Power Drive Unit, not shown) is installed between the motor 61 and the power controller 62 for generating a three-phase current in accordance with an instruction of the ECU 80.

The power controller 62 has a function of controlling the output (a generation power, a stack current, and a stack voltage) of the fuel cell stack 10 in accordance with the instruction from the ECU 80. The power controller 62 having the configuration descried above is configured with various electronic circuits such as a DC-DC chopper circuit. In addition the power controller 62 is connected to a battery (not shown). The power controller 62 also has a function of controlling charging and discharging the battery.

The contactor 63 is a switch for electrically connecting and disconnecting, i.e., electrically ON (connecting)/electrically OFF (disconnecting), the fuel cell stack 10 to or from an external circuit such as the motor 61.

The output detector 64 is a device for detecting a stack current value and a stack voltage value of the fuel cell stack 10 and includes a current sensor and a voltage sensor. The output detector 64 outputs and supplies the detected stack current value and the detected stack voltage value to the ECU 80.

### <Other Devices>

An IG 71 is a startup switch for the fuel cell system 1 (fuel cell vehicle) and installed around a driver's seat. The IG 71 is connected to the ECU 80 which is configured to detect an ON signal (system startup signal), an OFF signal (system stop signal) of the IG71.

### <ECU>

The ECU 80 is a controller for electronically controlling the fuel cell system 1 and includes a CPU, a ROM, a RAM, various interfaces, electronic circuits, etc. to control the various devices in accordance with a program stored therein to conduct various processes.

### <ECU-OCV Determining Function>

The ECU 80 (OCV determining unit) includes a function of determining whether an output voltage of a single cell 11 (averaged cell voltage or the minimum cell voltage) is not smaller than a predetermined OCV, i.e., whether the fuel cell stack 10 is in a power generation allowable state as a result of completion of substitution with a hydrogen gas or the air, on the basis of the OCV (averaged cell voltage or the minimum cell voltage) of the single cell 11 detected through the cell voltage monitor 15 at the startup of the system.

### <ECU-Stoichiometric Ratio Control Function (I-V Characteristic Lowering Function)>

The ECU 80 includes a function of controlling the stoichiometric ratio of oxygen supplied to the cathode by controlling (varying) a flow rate (supplying quantity) of the air toward the cathode flow passage 13 to control a flow rate (supply quantity) of the air (oxygen) toward the cathode flow passage 13 by controlling (varying) a rotational speed of the compressor 31 while a hydrogen quantity to the fuel cell stack 10 and an output voltage of the fuel cell stack 10 (signal cell 11) are fixed.

More specifically, the I-V characteristic decreasing unit includes the compressor 31, the power controller 62, and the ECU 80, the I-V characteristic decreasing unit operating the fuel cell system 1 in a low temperature startup mode for decreasing the stoichiometric ratio of the air (oxidant gas) to increase the heat generation quantity associated with the power generation by decreasing the I-V characteristic (I-V curve) of the fuel cell stack 10 (single cell 11) to accelerate the warm-up of the fuel cell stack 10 (single cell 11).

### <ECU-Warm-Up Determining Function>

The ECU 80 (warm-up determining unit) includes a function (1) of determining whether the operation in the low temperature startup mode for accelerating the warm-up of the fuel cell stack 10 at the startup of the system is necessary and a function (2) of determining whether the warm-up of the fuel cell stack 10 has completed during the low temperature startup mode or a general startup mode, on the basis of a temperature T1 of the coolant (temperature of the fuel cell stack 10) detected through the temperature sensor 54.

### <ECU-Cathode Pressure (Bypass Air Pressure) Control Function>

The ECU 80 includes a function of independently controlling an ejecting pressure (rotational speed) of the compressor 31 and the opening angle of the back pressure valve 32 to control (1) a pressure of the air in the cathode flow passage 13 (cathode pressure) and (2) a pressure of the bypass air introduced into the diluter 40. In other words, a pressure decreasing unit for decreasing the pressure of the bypass air introduced into the diluter 40 includes the compressor 31, the back pressure valve 32, and the ECU 80.

### <ECU-Target Heat Generation Quantity Calculating Function>

The ECU 80 includes a function of calculating a target heating quantity for the fuel cell stack 10 on the basis of the temperature T1 of the coolant (temperature of the fuel cell stack 10) detected through the temperature sensor 54.

### <<Fuel Cell System Operation and Advantageous Effect>>

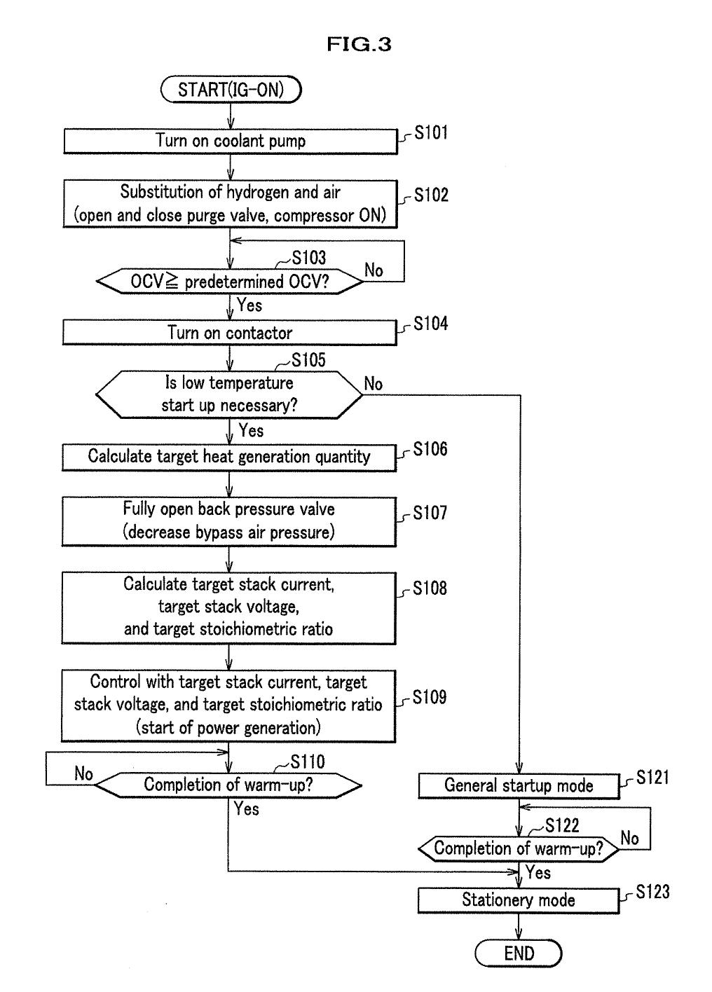

Next, with reference to FIG. 3, will be described an operation of the fuel cell system 1.

The operation method of the fuel cell system 1 includes an OCV determining step S103 of, at the startup of the system, determining whether an OCV of the single cell 11 (fuel cell) is equal to or greater than a predetermined OCV (S103), and I-V characteristic decreasing steps (S107 to S109) of starting the power generation of the fuel cell stack 10 and warming up the fuel cell stack 10 by decreasing the I-V characteristic of the fuel cell stack 10 (the single cell 11) by decreasing the stoichiometric ratio of oxygen after it is determined, in the OCV determining step, that the OCV equal to or greater than the predetermined OCV (Yes in S103). The operation method features that, in the I-V characteristic decreasing step S107, a pressure of the bypass air (in the pressure of the introducing chamber 42) introduced in the diluter 40 is decreased.

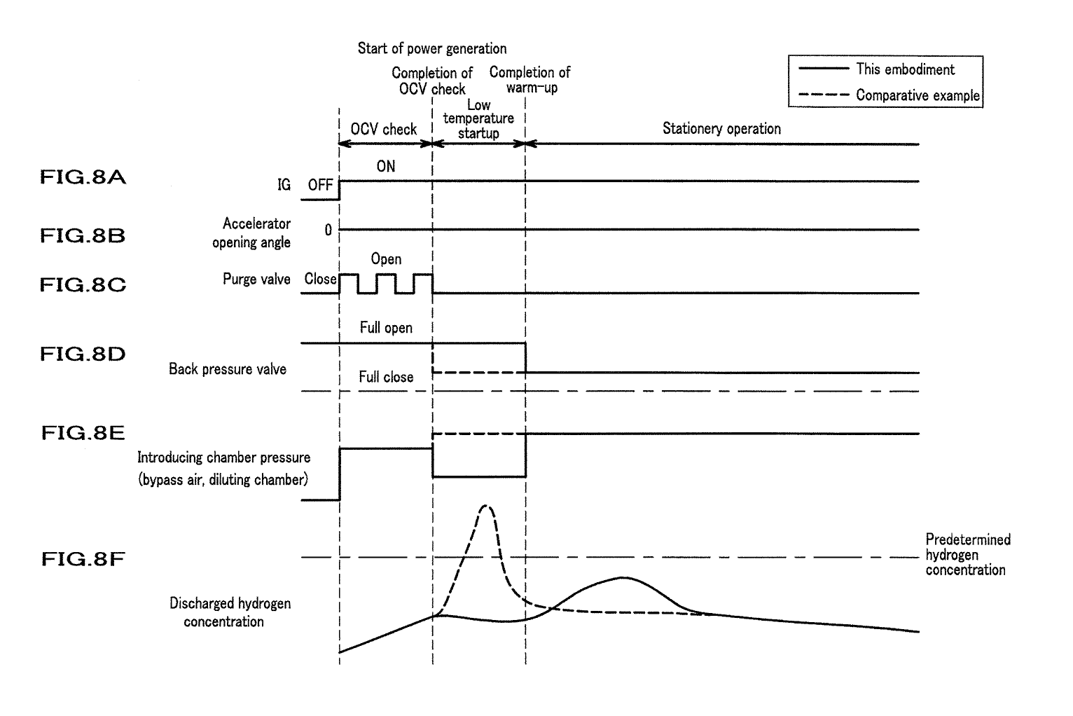

In addition, in the initial state (system stop status), the fuel cell stack 10 is in the power generation stop status. When the ECU 80 detects an ON signal of the IG 71 (FIG. 8A), the process in FIG. 3 starts.

In a step S101, the ECU 80 turns ON the coolant pump 51 to circulate the coolant. In this case, because the coolant is generally at a low temperature, the coolant flows through the pipe 52c to bypass around the radiator 53. During this operation, the accelerator opening angle is kept zero (FIG. 8B).

In a step S102, the ECU 80 substitutes a gas in the anode flow passage 12 with the hydrogen gas.

More specifically, the ECU 80 opens the purge valve 25 repeatedly for a predetermined opening period (see FIG. 8C) after opening the shutoff valve 22. Then the substitution of a gas in the anode flow passage 12 with the hydrogen gas is accelerated so that the hydrogen concentration increases.

In parallel to this, the ECU 80 substitutes a gas in the cathode flow passage 13 with the air (oxygen gas).

More specifically, the ECU 80 supplies the air to the cathode flow passage 13 by turning ON the compressor 31. Then, the substitution of a gas in the cathode flow passage 13 with the air is accelerated so that the oxygen concentration increases. In this example, the ECU 80 accelerates the substitution of the gas with the air by fully opening the back pressure valve 32 (opening angle: maximum) (see FIG. 8D).

This promotes the electrode reaction in each of the single cells 11 so that the OCV of the single cell 11 increases.

However, the opening angle of the back pressure valve 32 is not limited to the full opening angle, but may be an opening angle which is smaller value for rapidly increasing the OCV in substituting the gas with the air, i.e., the opening angle may be equivalent to the opening angle in the general startup mode (S121).

During the substitution of the gas in the cathode flow passage 13 with the air, though the opening angle of the back pressure valve 32 is set to, for example, the full open angle (see FIG. 8D) to accelerate the substitution, the cathode pressure (the pressure in the cathode flow passage 13) and the pressure in the pass-through pipe 43 are set to a higher side value than those during operation in the low temperature startup mode (S106 to S109), for example, pressure values substantially equal to those in the general startup mode (S121) (FIG. 8E). More specifically, an ejection pressure of the compressor 31 is set to a higher side value.

In the step S103, the ECU 80 determines whether the OCV of the single cell 11 (the averaged cell voltage or the minimum cell voltage) is equal to or greater than the predetermined OCV. The predetermined OCV is a value of the OCV at which it is determined that the fuel cell stack 10 can start to generate electric power, and is obtained by previous tests, and stored in the ECU 80 in advance.

In addition, the process from the step S102 to the step S103 corresponds to the OCV check process.

When it is determined that the OCV is equal to or greater than the predetermined OCV (Yes in the step S103), the processing of the ECU 80 proceeds to a step S104. When it is determined that the OCV is not equal to or greater than the predetermined OCV (No in the step S103), the ECU 80 repeats the determination in the step S103.

In the step S104, the ECU 80 turns ON the contactor 63. This electrically connects the fuel cell stack 10 to the external circuit including the motor 61, etc.

In a step S105, the ECU 80 determines whether it is necessary to operate (start up) the fuel cell system 1 in the low temperature startup mode (in a below zero startup mode). The low temperature startup mode is a mode for accelerating the warm-up of the fuel cell stack 10 because the fuel cell stack 10 is at a low temperature at the startup of the system by increasing a self heat generation quantity of the fuel cell stack 10 associated with the power generation by decreasing the I-V characteristic of the fuel cell stack 10 (the single cell 11) by controlling oxygen to a stoichiometric ratio in which oxygen lacks for the general startup mode (S121).

Here, when the temperature T1 of the coolant detected through the temperature sensor 54 (the temperature of the fuel cell stack 10) is equal to or smaller than a predetermined temperature, it is determined that operation should be made in the low temperature startup mode. The predetermined temperature corresponds to a temperature at which the warm-up acceleration is determined to be necessary for the fuel cell stack 10 (for example, 0 to 5 degrees centigrade) and is obtained through previous tests and stored in the ECU 80 in advance.

When it is determined that operation needs to be made in the low temperature startup mode (Yes in the step S105), processing of the ECU 80 proceeds to the step S106. When it is determined that operation does not need to be made in the low temperature startup mode (No in the step S105), the processing of the ECU 80 proceeds to the step S121.

### <General Startup Mode>

In the step S121, the ECU 80 operates the fuel cell system 1 in the general startup mode. The general startup mode is a mode for generally warming up the fuel cell stack 10 by the self heating associated with electric power generation, in which the fuel cell stack 10 is caused to generate the electric power with an output of which value at a side higher than that in, for example, an idling state (no load status) while hydrogen and oxygen are supplied to the fuel cell stack 10 at a general flow rate at a general pressure, the general flow rate and the general pressure being preset for the fuel cell stack 10. In such a general startup mode, the stoichiometric ratio of the air supplied to the cathode flow passage 13 is set to be a value at a higher side so as to make oxygen surplus.

In a step S122, the ECU 80 determines whether the warm-up of the fuel cell stack 10 has completed. Here, when the temperature T1 of the coolant detected through the temperature sensor 54 (temperature of the fuel cell stack 10) is equal to or higher than a predetermined warm-up completion temperature, it is determined that the warm-up for the fuel cell stack 10 has completed. The predetermined warm-up completion temperature is set to a temperature (for example, 40 to 60 degrees centigrade) that allows the temperature of the fuel cell stack 10 to reach a stationary operation temperature (for example, 80 to 90 degrees centigrade) by the self heating after the general startup mode for warming up has completed and the mode changes to the stationary mode.

When it is determined that the warm-up of the fuel cell stack 10 has competed (Yes in the step S122), the processing of the ECU 80 proceeds to a step S123. When it is determined that the warm-up of the fuel cell stack 10 has not competed (No in the step S122), the processing of the ECU 80 repeats the determination in the step S122.

### <Stationary Mode>

In the step S123, the ECU 80 operates the fuel cell system 1 in the stationary mode. More specifically, the ECU 80 causes the fuel cell stack 10 to generate an electricity while the ECU 80 supplies hydrogen and the air in accordance with a power generation demanded quantity (load demanded quantity) calculated on the basis of an accelerator opening angle, etc.

After this, the processing of the ECU 80 proceeds to END where a sequential process has finished.

### <Low Temperature Startup Mode>

Next, the processing in the low temperature startup mode performed because of “Yes in the step S105” will be described.

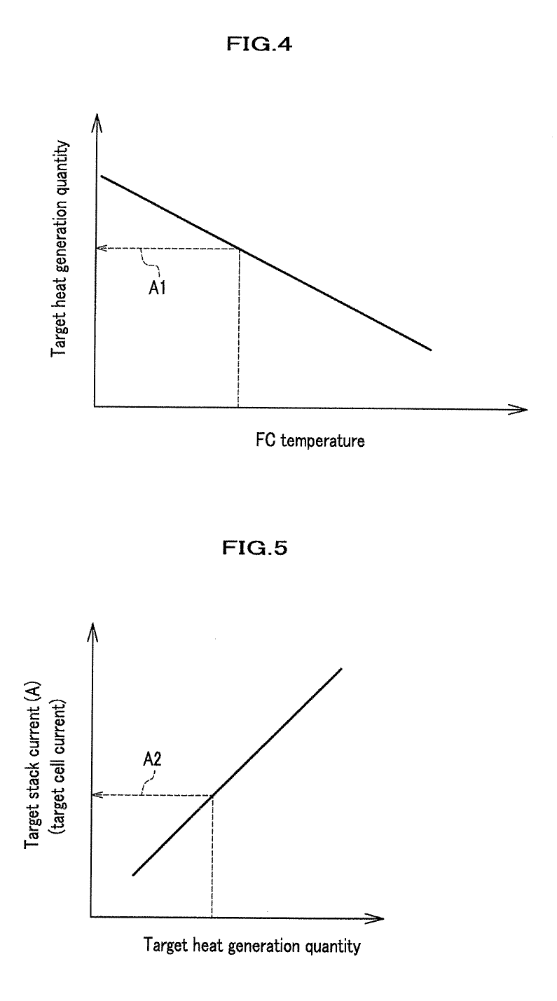

In the step S106, the ECU 80 calculates a target heat generation quantity. More specifically, the ECU 80 calculates the target heat generation quantity on the basis of the temperature sensor 54 and the map in FIG. 4 (see arrow A1). The map in FIG. 4 is obtained from previous tests and previously stored in the ECU 80. In addition, the ECU 80 may have such a configuration as to detect a remaining period up to the completion of the warm-up and correct the target heat generation quantity to be greater as the remaining period becomes short.

The target heat generation quantity is a heat generation quantity to be generated in the fuel cell stack 10 before the temperature (temperature T1 of the coolant) of the fuel cell stack 10 reaches the above-described predetermined warm-up completion temperature (for example, 40 to 60 degrees centigrade) and has such a relation that the target heat generation quantity becomes smaller as the temperature T1 of the fuel cell stack 10 increases (see FIG. 4).

In the step S107, the ECU 80 makes the opening angle of the back pressure valve 32 full. This decreases the cathode pressure (pressure in the cathode flow passage 13), the pressure of the bypass air introduced into the diluter 40, and the pressure in the introducing chamber 42 (the diluting chamber). In addition, the ECU 80 may be configured to make the opening angle of the back pressure valve 32 full after the start of the electric power generation of the fuel cell stack 10 in the step S109.

In the step S108, the ECU 80 calculates a target stack current, a target stack voltage, and a target stoichiometric ratio in the step S108. The target stack current is a target value of the current outputted by the fuel cell stack 10. In addition, because the fuel cell stack 10 has a configuration in which a plurality of the single cells 11 are electrically connected in series, the target stack current becomes equal to the target cell current (the target value of the current flowing through the single cell 11). On the other hand, the target stack voltage becomes equal to a total voltage that is a total of the target cell voltages.

More specifically, the ECU 80 calculates the target stack current (see an arrow A2) on the basis of the target heat generation quantity calculated in the step S106 and the map in FIG. 5. The map in FIG. 5 is obtained through previous tests, etc. and stored in the ECU 80 in advance. As shown in FIG. 5, there is a relation in which as the target heat generation quantity increases the target stack current increases.

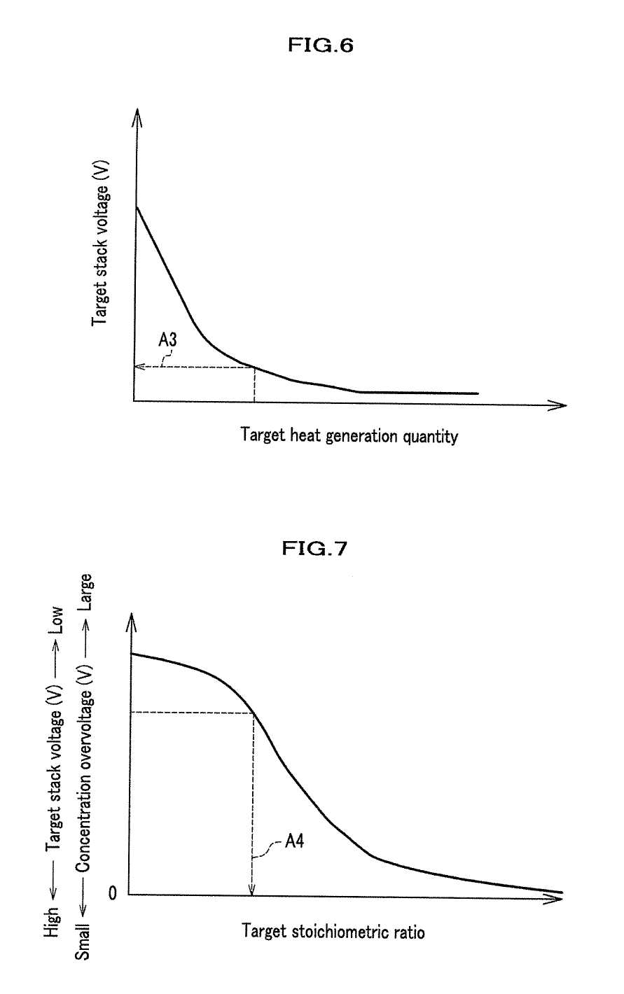

In addition, the ECU 80 calculates the target stack voltage (see an arrow A3) on the basis of the target heat generation quantity calculated in the step S106 and the map in FIG. 6. The map in FIG. 6 is obtained through previous tests, etc. and previously stored in the ECU 80. As shown in FIG. 6, there is a relation in which as the target heat generation quantity becomes larger, the target stack voltage rapidly decreases, and after that becomes close to the predetermined value.

In addition, the ECU 80 calculates the target stoichiometric ratio on the basis of the calculated target stack voltage and the map in FIG. 7 (see an arrow A4). The map in FIG. 7 is obtained through previous tests, etc., and previously stored in the ECU 80. As shown in FIG. 7, there is a relation in which as the target stack voltage decreases, the target stoichiometric ratio becomes smaller so as to increase the concentration over voltage.

In the step S109, the ECU 80 controls the fuel cell system 1 in accordance with the target stack current, the target stack voltage, and the target stoichiometric ratio calculated in the step S108.

More specifically, the ECU 80 outputs and supplies the target stack current to the power controller 62 as an instruction value. In response to this, the power controller 62 controls the current which the fuel cell stack 10 actually outputs. This causes the fuel cell stack 10 to start the electric power generation. In this case, the ECU 80 makes feedback to equalize the actual stack current detected through the output detector 64 to the target stack current.

In addition, the ECU 80 controls the flow rate of the air (oxygen) to have the target stoichiometric ratio, i.e., controls the rotational speed of the compressor 31. Here, to decrease the stoichiometric ratio of the air, the rotational speed of the compressor 31 is decreased relatively to that during the OCV check process (S102 to S103), so that the ejection quantity and the ejection pressure of the air from the compressor 31 will decrease.

In this case, because in the step S107 after completion of the OCV check process (S102 to S103), the back pressure valve 32 is fully opened, the pressure in the cathode flow passage 13, the pressure of the bypass air introduced into the diluter 40, and the pressure of the introducing chamber 42 (diluting chamber) decrease.

As described above, because the pressure of the bypass air and the pressure in the introducing chamber 42 (diluting chamber) have decreased (see FIG. 8D), a pressure at the upstream part of the introducing chamber 42 is substantially equal to the pressure in the pass-through pipe 43. In other words, because there is substantially no pressure difference, a gas flow substantially disappears in the introducing chamber 42.

According this, for example, though it is assumed that the anode off-gas has been introduced into the introducing chamber 42 as result of opening the purge valve 25 (see FIG. 8C) just before the completion of the OCV check process (just before Yes in the step S103), no gas flow is generated in the introducing chamber 42. Accordingly, a staying period of the anode off-gas in the introducing chamber 42 (diluting chamber) becomes longer, so that the hydrogen concentration preferably decreases by the self-diffusion, etc. In other words, because the suction quantity to the pass-through pipe 43 becomes low, the hydrogen concentration in the gas after diluting to be exhausted outside the vehicle (an exhausted hydrogen concentration) is kept equal to or less than a predetermined hydrogen concentration. The predetermined hydrogen concentration is an upper limit value of the hydrogen concentration at which hydrogen is allowed to be exhausted outside the vehicle and obtained through previous tests and stored in the ECU 80 in advance.

In this case, configuration may be also made as follows:

A second predetermined hydrogen concentration lower than the predetermined hydrogen concentration is set. When the hydrogen concentration detected by the hydrogen gas sensor 36 is equal to or greater than the second predetermined hydrogen concentration, to avoid increase in the hydrogen concentration after that, the rotational speed of the compressor 31 is decreased to decrease the suction quantity. In addition, the configuration may be made to temporarily inhibit the assist valve 37 from opening.

As described above, the fuel cell stack 10 is caused to generate an electric power with a low stoichiometric ratio of the air to rapidly warm up the fuel cell stack 10. During this, the hydrogen concentration of the diluted gas to be exhausted outside the vehicle is kept equal to or smaller than the predetermined hydrogen concentration.

In a step S110, the ECU 80 determines whether the warm-up of the fuel cell stack 10 has completed as similar to the step S122.

When the ECU 80 determines that the warm-up of the fuel cell stack 10 has completed (Yes in the step S110), the process of the ECU 80 proceeds to the step S123. When the ECU 80 determines that the warm-up of the fuel cell stack 10 has not completed (No in the step S110), the ECU 80 repeats a determination in the step S110.

As described above, because the pressure in the cathode flow passage 13, the pressure of the bypass air, and the pressure in the introducing chamber 42 (diluting chamber) are decreased after completion of the OCV check (after Yes in the step S103), the suction quantity to the pass-through pipe 43 (a suction flow rate into the pass-through pipe 43) becomes low, i.e., the staying period (holding period) of the anode off-gas in the introducing chamber 42 becomes long, though the anode off-gas has been introduced into the introducing chamber 42 just before the completion of the OCV check process.

Accordingly, continuous operation in the low temperature startup mode in which the stoichiometric ratio of the air is made low to decrease the I-V characteristic accelerates the rapid warm-up of the fuel cell stack 10 as well as the hydrogen concentration in the gas after diluting to be exhausted outside the vehicle can be kept equal to or smaller than the predetermined hydrogen concentration. In other word, there is no need to temporarily interrupt the operation in the low temperature startup mode to prevent lack in diluting hydrogen, so that there is no delay in warm-up of the fuel cell stack 10.

In the comparative example shown by a broken line in FIG. 8D, the back pressure valve 32 is fully closed in the low temperature startup period, so that the pressure of the introducing chamber 42 increases as shown by a broken line in FIG. 8E. Accordingly, the concentration rapidly increases and exceeds the predetermined hydrogen concentration and then decreases as shown by the broken line in FIG. 8F. On the other hand, in this embodiment, the back pressure valve 32 is fully opened in the low temperature startup period, so that the pressure of the introducing chamber 42 decreases as shown by a solid line in FIG. 8E. Though the concentration varies, but does not exceed the predetermined hydrogen concentration as shown by a solid line in FIG. 8F. Accordingly, a peak of the hydrogen concentration higher than the predetermined hydrogen concentration can be avoided.

### <<Modifications>>

As described above the embodiment of the present invention has been described. However, the present invention is not limited to this, but may be modified as follows:

In the embodiment described above, the configuration has been exemplified in which after the completion of the OCV check (Yes in the step S103), immediately the back pressure valve 32 is fully opened (S107) to decrease the cathode pressure (the pressure in the cathode flow passage 13) and the pressure in the pass-through pipe 43. However, the following configuration may be also provided.

After the completion of the OCV check (Yes in the step S103), the back pressure valve 32 is not immediately fully opened, but fully opened when, for example, the minimum voltage detected through the cell voltage monitor 15 becomes equal to or smaller than the predetermined minimum cell voltage because, in the low temperature startup mode, flooding or impurity (nitrogen, water vapor, etc.) increase, which causes the purge valve 25 to be opened. In other words, there may be a configuration in which the back pressure valve 32 is fully opened, which is linked with opening and closing of the purge valve 25, i.e., introducing the anode off-gas into the diluter 40.

This configuration keeps the hydrogen concentration in the gas after the dilution equal to or smaller then the predetermined hydrogen concentration because it becomes difficult for the anode off-gas to be sucked into the pass-through pipe 43, though the purge valve 25 is opened and the anode off-gas is introduced into the diluter 40.

In the embodiment described above, the configuration is exemplified in which the diluter 40 includes the pass-through pipe 43. However, there may be a configuration without the pass-through pipe 43. More specifically, there may be a configuration in which the cathode off-gas is introduced into the introducing chamber 42 through the pipe 32b and the gas after dilution is introduced into the pipe 32c from the introducing chamber 42.

In the embodiment described above, the configuration is exemplified in which the present invention is applied to the fuel cell stack 10 formed with a plurality of the single cells 11 connected in series. However, the present invention may be applied to a single cell 11.

In the embodiments, the configuration is exemplified in which the upstream end of the pipe 37a is connected to the pipe 31a (oxidant gas supplying flow passage). In addition, there may be, for example, a configuration in which the upstream end of the pipe 37a is connected to the pipe 32a (oxidant off-gas discharging flow passage between the cathode flow passage 13 and the diluter 40) instead of the pipe 31a, as shown by a broken line with an arrow.

In the embodiment described above, the configuration is exemplified in which the pressure of the bypass air is controlled by controlling the opening angle of the back pressure valve 32. In addition, there may be, for example, a configuration in which a regulator (pressure reducing valve) capable of controlling a secondary side pressure is installed in the pipe 37b and the pressure of the bypass air is controlled with the regulator.

In the embodiment described above, the fuel cell system 1 mounted on the fuel cell vehicle is exemplified. However, the embodiment is not limited to this configuration. For example, a fuel cell system of a stationary installation type may be provided.

### DESCRIPTION OF REFERENCE SYMBOL

1 fuel cell system
10 fuel cell stack (fuel cell)
11 single cell (fuel cell)
12 anode flow passage (fuel gas flow passage)
13 cathode flow passage (oxidant gas flow passage)
21 hydrogen gas tank (fuel gas supplying unit)
31 compressor (oxidant gas supplying unit, pressure control unit)
32 back pressure valve (pressure control unit)
40 diluter
41 box
42 introducing chamber
43 pass-through pipe
43a suction hole
62 power controller (I-V characteristic decreasing unit)
80 ECU (OCV determining unit, I-V characteristic decreasing unit, pressure control unit)

The invention claimed is:

1. A fuel cell system comprising:
a fuel cell, including a fuel gas flow passage and an oxidant gas flow passage, configured to generate an electric power with supply of the fuel gas to the fuel gas flow passage and the oxidant gas to the oxidant gas flow passage;
fuel gas supplying unit for supplying the fuel gas into the fuel gas flow passage;
an oxidant gas supplying unit for supplying the oxidant gas into the oxidant gas flow passage;
an oxidant gas supplying flow passage, extending from the oxidant gas supplying unit to the oxidant gas flow passage, through which the oxidant gas flows;
an oxidant off-gas discharge flow passage through which the oxidant off-gas discharged from the oxidant gas flow passage flows;
a diluter, installed in the oxidant off-gas discharge flow passage, configured to dilute the fuel off-gas discharged from the fuel gas flow passage with the oxidant off-gas;
a branched gas flow passage configured to connect the oxidant gas flow passage or the oxidant off-gas discharge flow passage upstream from the diluter to the diluter and allow a branched gas to flow toward the diluter;
a pressure controlling unit configured to control a pressure of the branched gas;
an OCV determining unit configured to determine whether an OCV of the fuel cell is equal to or greater than a predetermined OCV at a system startup; and
an I-V characteristic decreasing unit configured to start generation of the electric power in the fuel cell after the OCV determining unit determines that the OCV of the fuel cell is equal to or greater than the predetermined OCV and decreasing an I-V characteristic of the fuel cell by decreasing a stoichiometric ratio of the oxidant gas,
wherein the pressure controlling unit decreases the pressure of the branched gas introduced into the diluter when the I-V characteristic of the fuel cell is decreased by the I-V characteristic decreasing unit.

2. The fuel cell system as claimed in claim 1, wherein the diluter comprises:
a case including an introducing chamber into which the fuel off-gas is introduced;
an oxidant off-gas pipe, penetrating the case, through which the oxidant off-gas flows;
a suction hole, formed in the oxidant off-gas pipe in the case and providing communication between outside and inside of the oxidant off-gas pipe;
wherein with a decrease in a flow rate of the oxidant off-gas flowing through the oxidant off-gas pipe a suction quantity of the fuel off-gas suctioned into the oxidant off-gas pipe through the suction hole from the introducing chamber decreases.

3. The fuel cell system as claimed in claim 1, wherein the branched gas flow passage is connected to the oxidant gas supplying flow passage and the pressure controlling unit comprises a back pressure valve installed in the oxidant off-gas flow passage between the oxidant gas flow passage and the diluter.

4. A method of operating a fuel cell system comprising:
a fuel cell, including a fuel gas flow passage and an oxidant gas flow passage, configured to generate an electric power with supply of the fuel gas to the fuel gas flow passage and the oxidant gas to the oxidant gas flow passage;
fuel gas supplying unit for supplying the fuel gas into the fuel gas flow passage;
an oxidant gas supplying unit for supplying the oxidant gas into the oxidant gas flow passage;
an oxidant gas supplying flow passage, extending from the oxidant gas supplying unit to the oxidant gas flow passage, through which the oxidant gas flows;
an oxidant off-gas discharge flow passage through which the oxidant off-gas discharged from the oxidant gas flow passage flows;
a diluter, installed in the oxidant off-gas discharge flow passage, configured to dilute the fuel off-gas discharged from the fuel gas flow passage with the oxidant off-gas;
a branched gas flow passage configured to connect the oxidant gas flow passage or the oxidant off-gas discharge flow passage upstream from the diluter to the diluter and allow a branched gas to flow toward the diluter, the method comprising:
an OCV determining step of determining whether the OCV of the fuel cell at a system startup is equal to or greater than a predetermined OCV; and
an I-V characteristic decreasing step of starting generation of the electric power in the fuel cell after it is determined that the OCV of the fuel cell is equal to or greater than the predetermined OCV in the OCV determining step and decreasing an I-V characteristic of the fuel cell by decreasing a stoichiometric ratio of the oxidant gas, wherein a pressure of the branched gas introduced in the diluter is decreased in the I-V characteristic decreasing step.
